(19) United States
(12) Patent Application Publication
(10) Pub. No.: US 2025/0382462 A1
(43) Pub. Date: Dec. 18, 2025

(54) METHODS OF FORMING BIODEGRADABLE POLYMERIC MATERIALS AND THE BIODEGRADABLE POLYMERIC MATERIALS FORMED THROUGH THE METHODS

(71) Applicant: HONEYWELL INTERNATIONAL INC., Charlotte, NC (US)

(72) Inventors: Srinivas Cherukupalli, Hyderabad (IN); Himanshu Pathak, Navi Mumbai (IN)

(73) Assignee: HONEYWELL INTERNATIONAL INC., Charlotte, NC (US)

(21) Appl. No.: 19/181,449

(22) Filed: Apr. 17, 2025

Related U.S. Application Data
(60) Provisional application No. 63/655,151, filed on Jun. 3, 2024.

(51) Int. Cl. C08L 89/00

(52) U.S. Cl. CPC C08L 89/00; C08L 2201/06

(57) ABSTRACT

Methods of forming compostable polymeric materials and compostable polymeric materials formed through the methods are provided herein. In an embodiment, a method includes blending a biodegradable polymer chosen from a biodegradable polyester, a biodegradable polysaccharide, or combinations thereof, with a polymer-degrading enzyme and a plasticizer to form an intermediate composition. The intermediate composition is gel extruded to form the compostable polymeric material. In an embodiment, a compostable polymeric material is formed by a method comprising the recited steps.

### CROSS REFERENCE TO RELATED APPLICATION

This application claims the benefit of U.S. Provisional Application No. 63/655,151 filed Jun. 3, 2024.

### TECHNICAL FIELD

The present disclosure generally relates to methods of forming polymeric materials and polymeric materials formed through the methods. The present disclosure more particularly relates to methods of forming compostable polymeric materials and compostable polymeric materials formed through the methods.

### BACKGROUND

Polymeric materials are used in a variety of applications including packaging, labels, and disposable utensils. Polymeric materials are well suited for these applications due to the flexibility and durability of the materials. Commonly used polymers include polypropylene and polyethylene. Polymeric materials often contain additives dispersed throughout the polymer.

Despite the advantages of using polymeric materials in various applications, drawbacks are also known. Many polymeric materials end up in landfills or in the ocean, where they remain for an extended period of time or break down into microplastics. Recently, environmental preservation initiatives have increased in popularity, and some countries have even begun to pass legislation banning single-use (i.e. disposable) articles made from polymeric materials that are not biodegradable and/or compostable. Due to health, safety, and environmental concerns, there is an increasing demand for materials that are reusable and/or compostable. A compostable material is biodegradable (meaning it creates biomass rather than microplastics when it breaks down), and it breaks down over a specified period of time under various conditions defined in the ASTM compostability standards (e.g. ASTM 6400, ASTM D6868, ASTM D7081, ASTM D5929).

Some alternatives to single-use polymeric materials are currently in use. For example, in place of disposable plastic straws, reusable metal straws may be used. However, metal straws are expensive to make. Further, even though they are reusable, they may still be discarded in landfills or as litter in the environment, and they remain there as metal (i.e. they are not compostable, or even biodegradable). Compostable coated paper straws have also been developed. However, straws made from paper rather than from polymeric materials may fall apart when exposed to liquid during use, and glue used to hold the paper straws together may leach into a beverage. Further, consumers often do not have a satisfactory experience when using metal or paper straws.

To address the aforementioned problems, compostable polymeric materials have been developed for single or short-term use applications. Existing compostable polymeric materials are made of biodegradable polymers such as polylactic acid (PLA) and polybutylene adipate terephthalate (PBAT). The compostable polymeric materials may include additives such as calcium carbonate (CaCO₃) as a filler or enzymes to facilitate the breakdown of the polymeric materials. However, these existing compostable polymeric materials are generally suitable only for industrial composting and take too long to break down under milder conditions, such as when discarded in soil or marine environments. Thus, if the industrially compostable polymeric materials end up in landfills or in the ocean rather than in composting bins, the aforementioned problems remain. Further, traditional methods of forming existing compostable polymeric materials are inefficient and expensive. Existing compostable polymeric materials are difficult to form, and biodegradable polymers are prone to breakdown under conventional formation techniques such as melt extrusion.

Accordingly, it is desirable to provide methods of forming polymeric materials having maximized compostability. Further, it is desirable to provide methods of forming compostable polymeric materials with minimized processing times for extrusion. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods of forming compostable polymeric materials and compostable polymeric materials formed through the methods are provided herein. In an embodiment, a method includes blending a biodegradable polymer chosen from a biodegradable polyester, a biodegradable polysaccharide, or combinations thereof, with a polymer-degrading enzyme and a plasticizer to form an intermediate composition. The intermediate composition is gel extruded to form the compostable polymeric material. In an embodiment, a compostable polymeric material is formed by a method comprising the recited steps.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Compostable polymeric materials and methods of forming the compostable polymeric materials are provided herein that enable excellent compostability properties to be achieved as a result of blending a biodegradable polymer chosen from a biodegradable polyester, a biodegradable polysaccharide, or combinations thereof, a polymer-degrading enzyme, and a plasticizer to form an intermediate composition, and gel extruding the intermediate composition. Combining the enzyme and the biodegradable polymer chosen from a biodegradable polyester, a biodegradable polysaccharide, or combinations thereof, facilitates breakdown of the polymer after disposal of the compostable polymeric material, improving compostability under a variety of conditions. It has been found that adding the plasticizer to the biodegradable polymer chosen from a biodegradable polyester, a biodegradable polysaccharide, or combinations thereof, increases the melt flow index (MFI) of the intermediate composition and enables the intermediate composition to be processed to form the compostable polymeric material (i.e. extruded) at a faster pace than may currently be achievable with biodegradable polymers. Further, the increased MFI of the intermediate composition, owing to the plasticizer, allows for processing at milder conditions than would be possible without the plasticizer. Specifically, the intermediate composition can be gel extruded at lower temperatures than a traditional melt extrusion, which minimizes degradation of the enzyme. Minimized degradation of the enzyme leads to maximized enzyme activity (and thus excellent compostability) in the compostable polymeric material.

Unless specifically stated or obvious from context, as used herein, the term “about” is understood as within a range of normal tolerance in the art measured using standard measurement devices for a given measurement, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, a material that is “biodegradable” refers to a material that is capable of undergoing decomposition into carbon dioxide, methane, water, inorganic compounds, or biomass, through the enzymatic action of microorganisms, under any conditions and over any period of time. A biodegradable material may or may not be “compostable” as defined by the compostability test method of ASTM standard D6400. A biodegradable material may or may not be recyclable.

As used herein, a material that is “compostable” refers to a material that is capable of undergoing decomposition into carbon dioxide, methane, water, inorganic compounds, or biomass, through the enzymatic action of microorganisms, over a minimum of 90 days in an aerobic and controlled composting environment. The conditions required for the aerobic and controlled composting environment are described in the US industrial composting standards ASTM D6400 and ASTM D6868. Some compostable materials are capable of undergoing the described decomposition under less stringent conditions than required by ASTM D6400. For example, if a material is compostable under marine conditions (as defined in ASTM D7081), then more than 90% of the material degrades in less than six months, and more than 90% of the material disintegrates (i.e. breaks down into pieces measured less than 2 mm) in less than 84 days, in an environment having a temperature of from 20° C. to 25° C. As another example, if a material is compostable under soil conditions (as defined in ASTM D5929), then more than 90% of the material degrades in less than 24 months in an environment having a temperature of from 20° C. to 25° C.

The compostable polymeric materials provided herein comprise a biodegradable polymer chosen from a biodegradable polyester, a biodegradable polysaccharide, or combinations thereof; a polymer-degrading enzyme; and a plasticizer. The compostable polymeric materials are formed through a process comprising the steps of blending the biodegradable polymer chosen from a biodegradable polyester, a biodegradable polysaccharide, or combinations thereof, with the polymer-degrading enzyme and the plasticizer to form an intermediate composition, and gel extruding the intermediate composition to form the compostable polymeric material.

The biodegradable polymer as contemplated herein is chosen from a biodegradable polyester, a biodegradable polysaccharide, or combinations thereof. The biodegradable polymer, as contemplated herein, provides maximized compostability of the resulting compostable polymeric material. While biodegradable polymers may or may not be compostable, their biodegradability properties allow them to be more easily broken down by enzymes and microorganisms when they are incorporated into polymeric materials. The intermediate composition (and thus the resulting compostable polymeric material) may contain only one biodegradable polymer, or alternatively, the intermediate composition may contain more than one biodegradable polymer. The intermediate composition may contain any combination of biodegradable polymers chosen from a biodegradable polyester, a biodegradable polysaccharide, or combinations thereof.

As used herein, the “peak melting point” of a polymer refers to the temperature at which a differential scanning calorimeter (DSC) trace peaks, as measured with a scan rate of 10° C./min. In embodiments, suitable biodegradable polymers have a peak melting point of less than about 180° C., alternatively from about 100° C. to about 180° C., alternatively from about 165° C. to about 180° C., alternatively less than 165° C., alternatively from about 100° C. to about 165° C., alternatively from about 120° C. to about 165° C. In embodiments, suitable biodegradable polymers have a melt flow index (MFI) of less than about 6 g/10 min, alternatively from about 1 g/10 min to about 6 g/10 min, alternatively from about 2.5 g/10 min to about 6 g/10 min, alternatively less than about 5 g/10 min, alternatively from about 2 g/10 min to about 5 g/10 min, alternatively from about 4 g/10 min to about 5 g/10 min, as measured in accordance with ASTM D1238 at a temperature of 190° C. and with a load of 2.16 kg. It should be noted that, for any given polymer, the MFI may vary by about +/−2 g/10 min due to variability in weight average molecular weight of the polymer. The melt flow index represents the flowability of a polymer. A higher melt flow index indicates that the polymer is more flowable (i.e. flows more quickly) under the specified conditions. In general, biodegradable polymers chosen from a biodegradable polyester, a biodegradable polysaccharide, or combinations thereof, have lower melt flow indexes than non-biodegradable polymers (e.g. polypropylene or polyethylene).

In embodiments, the biodegradable polymer is a biodegradable polyester. The biodegradable polyester may be, for example, polylactic acid (PLA), polybutylene adipate terephthalate (PBAT), polycaprolactone (PCL), polybutylene succinate (PBS), polyethylene succinate (PES), polyhydroxy alkanoates (PHA), and/or combinations thereof. In an embodiment, the biodegradable polyester is PLA, PBAT, and/or combinations thereof. In embodiments, the biodegradable polymer is a biodegradable polysaccharide. The biodegradable polysaccharide may be, for example, cellulose, carrageenan, natural starches formed from corn, wheat, potato, rice, cassava, tapioca, arrowroot, and/or combinations thereof. In embodiments, biodegradable polymer(s) may be present in a total amount of at least 50 wt %, alternatively from about 50 wt % to less than 100 wt %, alternatively from about 80 wt % to about 95 wt %, based on a total weight of the intermediate composition.

A polymer-degrading enzyme is used in the methods provided herein to maximize compostability of the resulting compostable polymeric material. As used herein, a “polymer-degrading enzyme” refers to any enzyme that tends to break down a polymeric material over time. Polymer-degrading enzymes act to break down polymers under certain conditions, expediting the biodegradation process (and thus improving compostability). The intermediate composition (and thus the resulting compostable polymeric material) may contain only one polymer-degrading enzyme, or alternatively, the intermediate composition may contain more than one polymer-degrading enzyme. The intermediate composition may contain any combination of polymer-degrading enzymes. The type of polymer-degrading enzyme(s) present in the intermediate composition is chosen based on the type of biodegradable polymer(s) present in the intermediate composition. For example, if a biodegradable polyester is present, then a polyester-degrading enzyme is chosen. Alternatively and/or additionally, if a biodegradable polysaccharide is present, then a polysaccharide-degrading enzyme is chosen. In embodiments, the enzyme is encapsulated within a carrier material. In embodiments, the carrier material may be a polymer such as, for example, chitosan, alginate, polyethylene glycol, or polyvinyl alcohol. In embodiments, the carrier material may be a metal-organic framework. The encapsulation of the enzyme in the carrier material acts to inhibit degradation of the enzyme and allows the enzyme to remain inactive until it is exposed to certain composting conditions.

In embodiments, the polymer-degrading enzyme is selected from an oxidoreductase, a transferase, a hydrolase, a lyase, an isomerase, a ligase, and/or combinations thereof. In embodiments, the polymer-degrading enzyme is a microbial hydrolase that catalyzes hydrolysis reactions in the presence of water (e.g. hydrolysis of the ester bond in the biodegradable polyester). The microbial hydrolase may be selected from a lipase, an esterase, and/or combinations thereof. In embodiments, the polymer-degrading enzyme may originate from Acidovorax delafieldii, Amycolatopsis orientalis ssp. orientalis, Amycolatopsis sp. K104-1, Aspergillus oryzae, Brevundimonas sp. MRL-ANI, Cryptococcus sp. S-2, Cryptococcus flavus GB-1, Cryptococcus magnus, Fusarium sp. FS1301, Paenibacilus amylolyticus TB-13, Paraphoma-related fungus B47-9, Psudozyma antarctica JCM 10317, Ralstonia sp. MRL-TL, Thielavia terretris CAU709, and/or combinations thereof. In embodiments, the initial activity of the enzyme may be from about 1 KLU/g to about 25 KLU/g, alternatively from about 1 KLU/g to about 10 KLU/g, alternatively from about 1 KLU/g to about 5 KLU/g, alternatively from about 5 KLU/g to about 10 KLU/g. In embodiments, the enzyme may be present in an amount of from about 0.01 wt % to about 5 wt %, alternatively from about 0.01 wt % to about 1 wt. %, alternatively from about 0.1 wt % to about 1 wt %, based on a total weight of the intermediate composition. The amount of the enzyme may be determined based on the initial activity of the enzyme. For example, in an embodiment, if the initial activity of the enzyme is 5 KLU/g, then the amount of the enzyme is 1 wt %, based on a total weight of the intermediate composition.

The plasticizer is provided to modify the flow properties of the biodegradable polymer chosen from a biodegradable polyester, a biodegradable polysaccharide, or combinations thereof. Specifically, the plasticizer increases the MFI of the biodegradable polymer to make it more flowable at lower temperatures. As used herein, “plasticizer” refers to a substance that promotes plasticity and flexibility of a polymer, and that is different from the biodegradable polymer (i.e. is not a biodegradable polyester or a biodegradable polysaccharide). The intermediate composition (and thus the resulting compostable polymeric material) may contain only one plasticizer, or alternatively, the intermediate composition may contain more than one plasticizer. The intermediate composition may contain any combination of plasticizers as defined herein.

In embodiments, the plasticizer has a functional group that bonds with the biodegradable polymer (i.e. the plasticizer is incorporated into the polymer through bonding). As used herein, “bond” may refer to a chemical bond and/or a physical bond. In embodiments, the plasticizer is reactive with the biodegradable polymer to form a copolymer (i.e. a chemical reaction occurs to form a covalent bond between the plasticizer and the biodegradable polymer). In other embodiments, intermolecular forces form a physical or ionic bond between the plasticizer and the polymer (e.g. van der Waals forces or hydrogen bonding). Bonding between the plasticizer and the polymer inhibits the plasticizer from migrating out of the intermediate composition during extrusion. More importantly, bonding between the plasticizer and the polymer inhibits the plasticizer from migrating (i.e. leaching) out of the formed compostable polymeric material in its final application. For example, if the compostable polymeric material is formed into a straw, the bonding between the plasticizer and the polymer inhibits the plasticizer from migrating out of the straw into a beverage. In embodiments, the plasticizer has a molecular weight of at least about 5000 g/mol, alternatively from about 5000 g/mol to about 8000 g/mol, alternatively at least about 8000 g/mol, which contributes to minimized migration of the plasticizer out of the compostable polymeric material. A molecular weight in the recited range may be advantageous because it is low enough to contribute to the flowability of the intermediate composition but high enough to contribute to the thermal stability of the intermediate composition.

In embodiments, the plasticizer may be a fatty acid, a long-chain alcohol, or a polyol or polymerization product thereof. A polyol, as defined herein, is an organic molecule having more than one hydroxyl group. For example, the plasticizer may be polyethylene glycol, propylene glycol, glycerol, or combinations thereof. In other embodiments, the plasticizer may be an oil comprising a hydrocarbon chain. In embodiments, the plasticizer may exhibit antioxidant properties at typical environmental temperatures of from −20° C. to 70° C. In embodiments, the plasticizer may be present in an amount of from about 1 wt % to about 15 wt %, alternatively from about 1 wt % to about 10 wt %, alternatively from about 1.5 wt % to about 10 wt %, alternatively from about 1.5 wt % to about 8 wt %, alternatively from about 2 wt % to about 6 wt %, alternatively from about 2 wt % to about 4 wt %, based on a total weight of the intermediate composition.

In embodiments, other components may be provided in addition to the biodegradable polymer, enzyme, and plasticizer. In embodiments, a compatibilizer may be present. In embodiments, a particulate filler material may be present. The filler may be, for example, calcium carbonate or silica.

The biodegradable polymer, enzyme, and plasticizer are blended to ensure that all components are dispersed throughout the intermediate composition. In embodiments, the intermediate composition is visibly homogeneous. Dispersing the plasticizer throughout the intermediate composition increases the melt flow index (MFI) of the intermediate composition, which is necessary to enable the gel extrusion step, as described below. Dispersing the enzyme throughout the intermediate composition ensures that enzymatic action will take place throughout the compostable polymeric material after it is disposed, leading to improved compostability. In embodiments, blending may be conducted through a high shear mixing process, a low shear mixing process, a kneading process, and/or a dispersion mixing process. In embodiments, the blending may be conducted through a twin screw extrusion process and/or a single screw extrusion process. In embodiments, the twin screw extrusion process uses a twin screw extruder having at least 10% kneading elements. The type of blending process is selected based on the properties of the biodegradable polymer, plasticizer, and enzyme being blended. In embodiments, the blending step is carried out in an environment having a temperature of about 25° C. In embodiments, the biodegradable polymer, plasticizer, and enzyme may reach a temperature of from about 60° C. to about 70° C. during the blending step.

After the blending step is completed, the intermediate composition is formed. As used herein, “intermediate composition” refers to the composition that results from the blending step, but that has not yet been extruded. The intermediate composition contains the biodegradable polymer chosen from a biodegradable polyester, a biodegradable polysaccharide, or combinations thereof, the polymer-degrading enzyme, and the plasticizer. The intermediate composition may also contain reaction products of the biodegradable polymer and the plasticizer, other side reaction products, impurities, other components, and/or combinations thereof.

In embodiments, the intermediate composition has a melt flow index of at least about 4 g/10 min, alternatively from about 4 g/10 min to about 6 g/10 min, alternatively at least about 6 g/10 min, alternatively from about 6 g/10 min to about 7 g/10 min, alternatively at least about 7 g/10 min, alternatively from about 7 g/10 min to about 12 g/10 min, alternatively at least about 12 g/10 min, as measured in accordance with ASTM D1238 at a temperature of 190° C. and with a load of 2.16 kg. As described above, it should be noted that, for any given polymer, the MFI may vary by about +/−2 g/10 min due to variability in weight average molecular weight of the polymer. Notably, the MFI of the intermediate composition is higher than the MFI of at least some of the biodegradable polymer(s) present in the intermediate composition, due to the change in the flow properties of the polymer as a result of the plasticizer. The increased MFI leads to excellent flow properties of the intermediate composition. The flow properties of the intermediate composition allow the intermediate composition to be extruded at lower temperatures and at faster speeds than may be possible without use of the plasticizer. The benefits of extrusion at lower temperatures and faster speeds are described below.

The methods provided herein further include the step of gel extruding the intermediate composition to form the compostable polymeric material. As used herein, “gel extrusion” refers to an extrusion process in which a material is forced through a nozzle or die under controlled conditions to extrude a continuous profile of the desired shape, and wherein the material is in the form of a gel during the extrusion. As used herein, “gel” refers to a viscoelastic multicomponent system formed by a structure-forming component and an absorbed liquid. A gel exhibits both viscous and elastic characteristics when undergoing deformation. This means that a gel has flow properties characteristic of fluids, while having elastic properties making it incapable of irreversible deformations. As used herein, a “gel” has a melt flow index (MFI) of at least about 4 g/10 min, alternatively at least about 5 g/10 min, alternatively from about 5 g/10 min to about 12 g/10 min, alternatively at least 12 g/10 min, as measured in accordance with ASTM D1238 at a temperature of 190° C. with a load of 2.16 kg. In the methods provided herein, the presence of the plasticizer in the intermediate composition renders the intermediate composition a gel before and/or during extrusion. In the methods provided herein, the presence of the plasticizer affects the flow properties of the intermediate composition, allowing the intermediate composition to be gel extruded.

In a gel extrusion process, the material being extruded can be pushed through the extruder at a lower temperature than would be possible in a conventional hot melt extrusion process due to the unique flow properties of a gel. This allows for extrusion of biodegradable polymers which may be less heat resistant than non-biodegradable polymers traditionally used in polymeric films and that may break down under the heat of a traditional hot melt extrusion process. Further, the enzymes contained in the intermediate composition are generally sensitive to heat, so extrusion with minimized heating of the material allows for extrusion of the intermediate composition while minimizing degradation of the enzymes. Minimized degradation of the enzymes during extrusion leads to maximized enzyme activity in the resulting compostable polymeric material, yielding maximized compostability of the material. Extrusion at lower temperatures and faster processing times may also reduce the cost of the manufacturing process.

In embodiments, the gel extrusion process may use a single-screw extruder, or alternatively a twin screw extruder. In embodiments, the intermediate composition is extruded at a temperature below the peak melting point of the biodegradable polymer. In embodiments, the intermediate composition is extruded at a temperature of the intermediate composition of less than about 180° C., alternatively from about 100° C. to about 180° C., alternatively from about 165° C. to about 180° C., alternatively less than about 165° C., alternatively from about 100° C. to about 165° C.

In embodiments, the intermediate composition is extruded to form an article comprising the compostable polymeric material (i.e. the extrudate is a formed article). For example, the intermediate composition may be extruded to form a compostable polymeric tube (e.g. a straw) or sheet (e.g. a film or bag). In other embodiments, the compostable polymeric material (i.e. extrudate) is further formed into an article. For example, the intermediate composition may be extruded to form pellets or granules, and the pellets or granules may then be formed into an article such as a polymeric straw or bag. In addition to molded articles and multilayer films, the compostable polymeric material may take the form of fibers, foams, coatings, or dispersions after additional process steps. The compostable polymeric material may be formed into the article, for example, by blowing, casting, thermoforming, compression pressing, or milling.

In embodiments, the compostable polymeric material formed through the methods provided herein has a thickness of from about 10 micrometers to about 5000 micrometers, alternatively from about 10 micrometers to about 150 micrometers, alternatively from about 50 micrometers to about 5000 micrometers.

In one specific embodiment, the compostable polymeric material comprises polybutylene adipate terephthalate (PBAT) as the biodegradable polymer, a hydrolase as the polymer-degrading enzyme, and polyethylene glycol (PEG) as the plasticizer. In this embodiment, the PEG is reactive with the PBAT to form a copolymer (i.e. a chemical reaction occurs to form a covalent bond between the plasticizer and the biodegradable polymer).

In embodiments, the compostable polymeric materials provided herein are contained in composite articles. The composite articles provided herein comprise the compostable polymeric material, a primer layer bonded to the compostable polymeric material, and an additional layer having a composition different from that of the compostable polymeric material and the primer layer, bonded to the primer layer on a side of the primer layer opposite of the compostable polymeric material. In embodiments, the composite article is a multilayer film or bag. In other embodiments, the composite article is a coated surface. For example, the composite article may be a laminated paper. In embodiments, the composite article is a multilayer tube such as a straw. The composite article may exhibit improved properties such as strength, moldability, flexibility, and compostability as compared to an article comprising only one layer, and/or as compared to a multilayer article that does not contain the compostable polymeric material.

The composite article may contain only one primer layer, or the composite article may contain more than one primer layer. In embodiments, the primer layer may comprise polyethylene glycol, glycerol, tributyl citrate, or PLA oligomers. The primer layer improves bonding of the compostable polymeric material to the additional layer. Further, the primer layer may provide resistance to degradation during use of the composite article (e.g. during submersion in a beverage if the composite article is a straw).

The composite article may contain only one additional layer, or the composite article may contain more than one additional layer. The additional layer may be a polymeric material or the additional layer may be something other than a polymeric material. If the additional layer is a polymeric material, the additional layer may contain biodegradable polymers, or alternatively, the additional layer may not contain biodegradable polymers. The additional layer may or may not be compostable. The additional layer may provide moldability benefits, hydrophobicity benefits, and/or other performance benefits. In embodiments, the additional layer may be an antioxidant layer having antioxidant properties.

In embodiments, the additional layer is a polysaccharide coating. The polysaccharide coating degrades under certain conditions, such as under marine or aquatic conditions. Thus, if the composite article is discarded into the environment, the degradation of the polysaccharide coating removes the protection provided by the additional layer (i.e. the polysaccharide coating), and kickstarts degradation of the underlying primer layer and compostable polymeric material. Therefore, the polysaccharide coating improves compostability of the composite article under certain conditions. In embodiments, the composite article is a straw comprising the compostable polymeric material, the primer layer, and the polysaccharide coating. The polysaccharide coating on the straw can withstand the conditions of a beverage during use of the straw, but breaks down under certain composting conditions.

In embodiments, the composite article is resistant to leaching of the plasticizer. In an embodiment, less than about 0.1 wt % of the plasticizer, based on a total weight of the plasticizer in the compostable polymeric material, migrates out of the composite article when exposed to a 3 wt % aqueous acetic acid solution for 4 hours at a temperature of the acetic acid solution of about 70° C. Leaching of the plasticizer may cause contamination of the environment in which the composite article is used. For example, if the composite article is a straw, then leaching of the plasticizer may contaminate the beverage that the straw is being used in.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

### EXAMPLES

### Reference Example 1

Precipitated Silica (500 grams) and Glycerol (500 grams) were first blended in a high-speed mixer (Jogindra Engineering JJH-010) for 10 minutes. Thereafter, the blend was added to a kneader containing 1000 grams of native corn starch. The kneader was operated for 30 minutes resulting in a thermoplastic starch (TPS) dough. The dough was run through a single screw extruder with die-cutter to produce TPS pellets.

A dry mixture was prepared in a high-speed mixer of the following elements-pulverized PLA (LX175 Total Corbion) and pulverized PBAT (Kingfa KB100LF) in a ratio between 1:1 and 1.5:1. A plasticizer mix including a plasticizer having a molecular weight of at least about 5000 g/mol and having functional groups that bond with the PLA/PBAT was added in an amount of 8-12 wt. % of the PLA/PBAT mix. The TPS pellets were added in an amount of 3 wt. % based on the total weight of the mixture. A compatibilizer (Aadibio 9100), Calcium carbonate powder, precipitated Silica powder, and processing additives were included in a total amount of about 15 wt. % based on the total weight of the mixture. The high-speed mixer was run for 15 minutes with the above-mentioned composition. Melt flow index of the compounded material (the intermediate composition) was at least 8.5 g/10 min, as measured in accordance with ASTM D1238 at a temperature of 190° C. and with a load of 2.16 kg.

In a twin-screw extruder (Useon 20, Nanjing Extrusion) with about 20% kneading block elements, L/D of 48/1, and screw diameter of 22 mm, the intermediate composition mentioned above was fed through a loss in weight hopper. The strand die was maintained at a temperature of 150-160° C. and the intermediate composition was pelletized under water cooling. Vacuum pull was maintained to reduce the amount of water absorbed into the intermediate composition. The resultant pellets were oven dried at a temperature of 55° C. for 4 hours, until the percentage of water absorbed was less than 0.5%.

Then, the intermediate composition was run on a single screw extruder with a tubular cross-section die maintained at 155° C. As the extrudate exits the die, it is taken through a water bath of 2 m to cool while the material is formed in the form of a beverage straw (tubular). Straws each of 0.5 grams were slit and collected. The straws were then corrugated and bent into a ‘U’ shape before getting packaged.

Samples prepared as per above compositions were tested according to IS/ISO 17556:2019 for determination of the ultimate aerobic biodegradability of plastic materials in soil by measuring the oxygen demand in a respirometer or the amount of carbon dioxide evolved. The tests were conducted at an external accredited lab for a period of 310 days, until the percent biodegradation of the reference samples reaches at least 90%. The final outcome is given in Table 1 below.

TABLE 1
Biodegradation Over Time In Soil Conditions

| | Percent Biodegradation - | Percent Biodegradation - |
|---|---|---|
| Days | Positive Control | Reference Example 1 |
| 45 | 61.03 | 5.91 |
| 90 | 91.14 | 11.14 |
| 135 | 100.00 | 29.48 |
| 180 | — | 50.20 |
| 225 | — | 68.40 |
| 270 | — | 79.50 |
| 310 | — | 92.35 |

The positive control is a microcrystalline cellulose powder that was subjected to the same conditions as the reference example. The results in Table 1 show that the microcrystalline cellulose powder reached 100% biodegradation after 135 days, and the reference example reached 92.35% biodegradation after 310 days.

### Example 2

Samples were prepared according to the procedure outlined for Reference Example 1, except that 1% of a hydrolase enzyme with an initial activity of 5 KLU/g was added to the compound in the dry-mix stage. In this case, the high-speed mixer was run for 30 minutes to have a uniform distribution of the additive. The intermediate composition was then extruded in a twin-screw extruder with the die temperature at 155° C. The resulting material is expected to have a higher propensity for biodegradation under milder exposure conditions, such as for home and soil biodegradation, as compared to Reference Example 1 and conventional materials including similar amounts of enzyme but that are prepared at higher processing temperatures.

What is claimed is:

1. A method of forming a compostable polymeric material, the method comprising the steps of:
blending a biodegradable polymer chosen from a biodegradable polyester, a biodegradable polysaccharide, or combinations thereof, with a polymer-degrading enzyme and a plasticizer to form an intermediate composition; and
gel extruding the intermediate composition to form the compostable polymeric material.

2. The method of claim 1, wherein the intermediate composition is extruded at a temperature of the intermediate composition that is below the peak melting point of the biodegradable polymer.

3. The method of claim 1, wherein the intermediate composition is extruded at a temperature of the intermediate composition of less than about 180° C.

4. The method of claim 1, wherein the intermediate composition is extruded to form an article comprising the compostable polymeric material.

5. The method of claim 1, further comprising forming the compostable polymeric material into an article.

6. The method of claim 1, wherein the intermediate composition has a melt flow index of at least about 4 g/10 min, as measured in accordance with ASTM D1238 at a temperature of 190° C. and with a load of 2.16 kg.

7. The method of claim 1, wherein the biodegradable polymer is blended with the plasticizer, wherein the plasticizer has functional groups that bond with the biodegradable polymer.

8. The method of claim 1, wherein the biodegradable polymer is blended with the plasticizer, wherein the plasticizer has a molecular weight of at least about 5000 g/mol.

9. The method of claim 1, wherein the biodegradable polymer is a biodegradable polyester.

10. The method of claim 9, wherein the biodegradable polyester is selected from polylactic acid, polybutylene adipate terephthalate, and/or combinations thereof, and wherein the biodegradable polyester is blended with the polymer-degrading enzyme and the plasticizer.

11. The method of claim 1, wherein the biodegradable polymer has a peak melting point of less than about 165° C., as measured with a differential scanning calorimeter at a scan rate of 10° C./min.

12. The method of claim 1, wherein the biodegradable polymer is blended with the polymer-degrading enzyme, wherein the enzyme is encapsulated within a carrier material.

13. A compostable polymeric material formed through a method comprising the steps of:
blending a biodegradable polymer chosen from a biodegradable polyester, a biodegradable polysaccharide, or combinations thereof, with a polymer-degrading enzyme and a plasticizer to form an intermediate composition; and
gel extruding the intermediate composition to form the compostable polymeric material.

14. A composite article, comprising:
the compostable polymeric material of claim 13;
a primer layer bonded to the compostable polymeric material; and
an additional layer having a composition different from that of the compostable polymeric material and the primer layer, bonded to the primer layer on a side of the primer layer opposite of the compostable polymeric material.

15. The composite article of claim 14, wherein the additional layer is a polysaccharide coating.

16. The composite article of claim 14, wherein less than about 0.1 wt % of the plasticizer, based on a total weight of the plasticizer in the compostable polymeric material, migrates out of the composite article when exposed to a 3 wt % aqueous acetic acid solution for 4 hours at a temperature of the acetic acid solution of about 70° C.
